(19) United States
(12) Patent Application Publication
(10) Pub. No.: US 2021/0233401 A1
(43) Pub. Date: Jul. 29, 2021

(54) System and Method for the Real-Time Identification of Hazardous Locations in Road Traffic

(71) Applicant: Bayerische Motoren Werke Aktiengesellschaft, Muenchen (DE)

(72) Inventors: Michael BRAUN, Muenchen (DE); Florian WEBER, Muenchen (DE)

(21) Appl. No.: 17/161,524

(22) Filed: Jan. 28, 2021

(30) Foreign Application Priority Data
Jan. 29, 2020 (DE) 10 2020 102 107.0

(51) Int. Cl. G08G 1/0967; G06K 9/00; G08G 1/01; G07C 5/00

(52) U.S. Cl. CPC G08G 1/096791; G06K 9/00845; G07C 5/008; G08G 1/0141; G08G 1/0133

(57) ABSTRACT

A system and method for the real-time identification of hazardous locations in road traffic includes a back end and at least one vehicle. Each vehicle includes a sensor unit that collects state data about the occupants of the vehicle. A computing unit processes the collected state data to determine a potential hazard based on the processed state data. An interaction unit interacts with the vehicle occupants in the case of an identified potential hazard, and identifies a hazardous location in road traffic, based on the interaction with the vehicle occupants. A communication unit transmits the identified hazardous location to the back end.

### CROSS REFERENCE TO RELATED APPLICATION

This application claims priority under 35 U.S.C. § 119 from German Patent Application No. 10 2020 102 107.0, filed Jan. 29, 2020, the entire disclosure of which is herein expressly incorporated by reference.

### BACKGROUND AND SUMMARY OF THE INVENTION

The present invention relates to a system and a method for the real-time identification of hazardous locations in road traffic.

Hazardous locations are appearing ever more frequently and abruptly in road traffic, in no small part due to the increase in traffic density. These hazards can result, for example, from a situation which occurs suddenly, for example, an accident which has just happened, the sudden onset of bad weather, a vehicle which has been left standing on the roadway, animals or objects on the roadway, etc. For this purpose, traffic information services or traffic information services are known from the prior art, which provide information about current traffic obstructions via a variety of media. The data used by traffic situation services originate mostly from data sources of the police, road maintenance facilities, automobile clubs, traffic alerts, road sensors, floating phone data, floating car data, etc. It is disadvantageous that the data must first be collected by the data sources, transmitted to the traffic situation service, and processed there accordingly. This can result in a non-trivial time difference between the occurrence of the hazardous situation and the provision of information about said situation via the traffic information service.

An object of the present disclosure is to provide a solution which enables an up-to-date identification of hazardous locations in road traffic, in near-real time.

This object is achieved according to the present invention via the features of the independent claims. Preferred embodiments are disclosed in the dependent claims.

The aforementioned object is achieved via a system for the real-time identification of hazardous locations in road traffic, comprising: a back end; at least one vehicle, comprising: a sensor unit which is configured to collect state data about the occupants of the vehicle; a computing unit which is configured: to process the collected state data; and to determine a potential hazard from the processed state data; and an interaction unit which is configured to interact with the vehicle occupants in the case of an identified potential hazard; and to identify a hazardous location in road traffic by means of the interaction with the vehicle occupants; and a communication unit which is configured to transmit the identified hazardous location to the back end.

The back end can comprise at least one back-end server and/or can be part of cloud computing or an IT infrastructure which provides memory, computing power, and/or application software as a service (service provider) via the Internet.

The vehicle may comprise any mobile means of transport which are used for transporting people (passenger traffic), goods (freight traffic) or tools (machines or auxiliary materials). In particular, the vehicle comprises motor vehicles and motor vehicles which can be driven electrically at least to a certain extent (electric cars, hybrid cars).

The vehicle can be controlled by a vehicle driver. In addition, or alternatively, the vehicle can be a vehicle which drives in an at least partially automated manner. Within the scope of the document, the term “vehicle driving in an automated manner” may be understood to mean driving using automated longitudinal or lateral guidance, or automated driving using automated longitudinal and lateral guidance. The automated driving may, for example, comprise driving for a longer period of time on the motorway, or driving for a limited period of time while parking or maneuvering. The term “automated driving” comprises automated driving having any arbitrary level of automation. Examples of levels of automation include assisted, partially automated, highly automated, or fully automated driving. These levels of automation have been defined by the German Federal Highway Research Institute (BASt) (see BASt publication “Forschung kompakt,” edition 11/2012). In assisted driving, the driver continuously performs the longitudinal or lateral guidance, while the system assumes the respective other function within certain limits. In partially automated driving, the system assumes the longitudinal and lateral guidance for a certain period of time and/or in specific situations, wherein the driver must monitor the system continuously, as in assisted driving. In highly automated driving, the system assumes the longitudinal and lateral guidance for a certain period of time, without the driver having to monitor the system continuously; however, the driver must be capable of assuming the guidance of the vehicle within a certain period of time. In fully automated driving, the system can automatically handle the driving in all situations for a specific application case; a driver is no longer needed for this application case. The aforementioned four levels of automation correspond to SAE Levels 1 to 4 of the SAE (Society of Automotive Engineering) J3016 standard. Furthermore, SAE Level 5 is designated as the highest automation level in SAE J3016, but is not included in the definition of the BASt. SAE Level 5 corresponds to driverless driving, in which the system is able to handle all situations automatically like a human driver during the entire trip.

The vehicle comprises a sensor unit which is configured to collect state data about the occupants of the vehicle.

In addition, the vehicle comprises a computing unit which is configured to process the collected state data and to determine a potential hazard based on the processed state data. This can take place with the aid of suitable machine learning algorithms. For example, with the aid of models which are created by machine-learning methods, for example, by means of monitored learning or supervised learning or unmonitored learning or unsupervised learning, certain occupant states and/or a combination of states can be classified and/or learned as indicating a risk situation.

The vehicle comprises an interaction unit which is configured to interact with the vehicle occupants in the case of an identified potential hazard, in order to identify a hazardous location in road traffic by means of the interaction with the vehicle occupants. The interaction unit can be an intelligent personal assistant (IPA). An IPA is software which can query information, conduct dialogues with humans, and provide assistance-services by means of communication in natural, human language, by performing a speech analysis for the purpose of speech recognition. The IPA is able to interpret the speech analysis semantically, to process it logically, and to formulate a response as a result, by means of speech synthesis.

For example, the interaction unit can be configured to inquire specifically why a particular state or a particular combination of states exists for one or several vehicle occupants which was determined to be a potential hazard. This may, for example, comprise a specific inquiry: “I have detected an exclamation of fright/disgust. In addition, I have determined that all vehicle occupants have an elevated pulse rate. Has something happened on the roadway?” Based on the response by the vehicle occupant or occupants, for example, “yes, a car is on fire” or “no, we're just having a silly argument,” the interaction unit can identify a hazardous location in road traffic.

In addition, the vehicle comprises a communication unit. This communication unit is configured to transmit the identified hazardous location to the back end.

The communication unit can be a communication unit which is arranged in the vehicle and which is configured to establish a communication link to other communication subscribers, for example, a back end and/or a mobile terminal device which is associated with the vehicle. The communication unit can comprise a subscriber identity module or a SIM card which is used to establish a communication link via a mobile radio system. The subscriber identity module identifies the communication unit unambiguously in the mobile radio network. The communication link can be a data link (for example, packet switching) and/or a wired communication link (for example, circuit switching). The communication can take place according to the Cellular Vehicle-to-X (C-V2X) paradigm in compliance with the LTE Standard Version 14. In addition, the communication unit can communicate via a different air interface, for example, WLAN, independently of the mobile radio network or the availability of sufficient capacity of the mobile radio network which is currently available. For this purpose, IST-G5 or IEEE 802.11p can be used for vehicle-to-vehicle (V2V) communication.

Advantageously, by means of targeted interaction with the vehicle occupants, a potential hazard can be identified in near-real time, which is not exactly possible by means of a pure sensor data evaluation.

Preferably, the sensor unit comprises:
at least one interior camera which is configured to collect data with respect to a current state of the vehicle occupants, wherein the state data comprise the data of the interior camera; and/or
at least one microphone which is configured to detect sounds made by the vehicle occupants, wherein the state data comprise the data of the microphone; and/or
at least one wearable which is configured to collect physiological data about the vehicle occupants, wherein the state data comprise the data of the wearables; and/or
at least one ECG seat which is configured to collect physiological data about the vehicle occupants, wherein the state data comprise the data of the ECG seat; and/or
at least one other sensor which is configured to collect data with respect to a current state of the vehicle occupants; wherein the driving behavior data comprise the collected data of the at least one other sensor.

The sensor unit can comprise at least one interior camera which is configured to collect data with respect to a current state of the vehicle occupants, wherein the state data comprise the data of the interior camera. In this case, the computing unit can be configured to determine states of the vehicle occupants, for example, body movements, facial features, eye movements, changes in face color, emotional state, etc., from the collected state data of the at least one passenger compartment camera, with the aid of suitable machine-learning algorithms.

In addition, or alternatively, the sensor unit can comprise at least one microphone which is configured to detect sounds made by the vehicle occupants, wherein the state data comprise the data of the microphone. In this case, the computing unit can be configured to determine states of the vehicle occupants, for example, sounds, words, word combinations, etc., from the collected state data of the at least one microphone, with the aid of suitable machine-learning algorithms.

In addition, or alternatively, the sensor unit can comprise at least one wearable which is configured to collect physiological data about the vehicle occupants, wherein the state data comprise the data of the wearable. In this case, the computing unit can be configured to determine states of the vehicle occupants, for example, changes in the stress level, sudden movements, sudden increases or decreases in the pulse rate, etc., from the collected state data of the at least one wearable, with the aid of suitable machine-learning algorithms.

In addition, or alternatively, the sensor unit can comprise at least one ECG seat which is configured to collect physiological data about a vehicle occupant, wherein the state data comprise the data of the ECG seat. In this case, the computing unit can be configured to determine states of the vehicle occupants, for example, a sudden increase or a sudden decrease in the blood pressure, suddenly occurring irregularities in the heartbeat, etc., from the collected state data of the at least one ECG seat, with the aid of suitable machine-learning algorithms.

In addition, or alternatively, the sensor unit can comprise at least one other sensor which is configured to collect data with respect to a current state of the vehicle occupants; wherein the driving behavior data comprise the collected data of the at least one other sensor. In this case, the computing unit can be configured to determine states of the vehicle occupants from the collected state data of the at least one additional sensor, with the aid of suitable machine-learning algorithms.

Particular states and/or any arbitrary combination of particular states of the vehicle occupants can be classified and/or learned as indicating a potential hazard, such that the computing unit can determine the potential hazard with the aid of suitable machine-learning algorithms.

Preferably, the back end is configured to transmit warning data with respect to the identified hazardous location to a plurality of vehicles, and/or to transmit a route detour around the identified hazardous location to a plurality of vehicles, of which the current route comprises or potentially comprises the identified hazardous location.

Advantageously, the hazardous situation can thus be transmitted to a plurality of vehicles in near-real time, in particular if their current route comprises the identified hazardous location.

A method for the real-time identification of hazardous locations in road traffic, according to at least one embodiment, comprises: collecting state data about the occupants of the vehicle by means of a sensor unit of a vehicle; processing the collected state data by means of a computing unit of the vehicle; determining a potential hazard from the processed state data, by means of the computing unit; interacting with the vehicle occupants by means of an interaction unit of the vehicle; identifying a hazardous location in road traffic by means of an interaction unit, based on the interaction with the vehicle occupants; and transmitting the identified hazardous location to a back end, by means of a communication unit of the vehicle.

Preferably, the sensor unit comprises:
at least one interior camera which is configured to collect data with respect to a current state of the vehicle occupants, wherein the state data comprise the data of the interior camera; and/or
at least one microphone which is configured to detect sounds made by the vehicle occupants, wherein the state data comprise the data of the microphone; and/or
at least one wearable which is configured to collect physiological data about the vehicle occupants, wherein the state data comprise the data of the wearables; and/or
at least one ECG seat which is configured to collect physiological data about the vehicle occupants, wherein the state data comprise the data of the ECG seat; and/or
at least one other sensor which is configured to collect data with respect to a current state of the vehicle occupants; wherein the driving behavior data comprise the collected data of the at least one other sensor.

Preferably, the back end is configured: to transmit warning data with respect to the identified hazardous location to a plurality of vehicles, and/or to transmit a route detour around the identified hazardous location to a plurality of vehicles, of which the current route comprises the identified hazardous location.

These and other objects, features, and advantages of the present invention will be illustrated from the study of the following detailed description of preferred embodiments and the attached figures. It is apparent that, although embodiments are described separately, individual features can be combined from them to form additional embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically depicts a system for the real-time identification of hazardous locations in road traffic; and

FIG. 2 depicts an exemplary method for the real-time identification of hazardous locations in road traffic.

### DETAILED DESCRIPTION OF THE DRAWINGS

The system 100 comprises a back end 120. The back end 120 can comprise at least one back-end server and/or can be part of cloud computing or an IT infrastructure which provides memory, computing power, and/or application software as a service (service provider) via the Internet.

The system 100 comprises at least one vehicle 110. The vehicle comprises a sensor unit 112 which is configured to collect state data about the occupants of the vehicle 110. In addition, the vehicle 110 comprises a computing unit 114 which is configured to process the collected state data and to determine a potential hazard based on the processed state data. This can take place with the aid of suitable machine learning algorithms. For example, with the aid of models which are created by machine-learning methods, for example, by means of monitored learning or supervised learning, or by means of unmonitored learning or unsupervised learning, certain occupant states and/or a combination of states can be classified and/or learned as indicating a hazardous situation.

The sensor unit 112 can comprise at least one interior camera which is configured to collect data with respect to a current state of the vehicle occupants, wherein the state data comprise the data of the interior camera. In this case, the computing unit 114 can be configured to determine states of the vehicle occupants, for example, body movements, facial features, eye movements, changes in face color, emotional state, etc., from the collected state data of the at least one passenger compartment camera, with the aid of suitable machine-learning algorithms.

In addition, or alternatively, the sensor unit 112 can comprise at least one microphone which is configured to detect sounds made by the vehicle occupants, wherein the state data comprise the data of the microphone. In this case, the computing unit can be configured to determine states of the vehicle occupants, for example, sounds, words, word combinations, etc., from the collected state data of the at least one microphone, with the aid of suitable machine-learning algorithms.

In addition, or alternatively, the sensor unit 112 can comprise at least one wearable which is configured to collect physiological data about the vehicle occupants, wherein the state data comprise the data of the wearable. In this case, the computing unit 114 can be configured to determine states of the occupants, for example, changes in the stress level, sudden movements, sudden increases or decreases in the pulse rate, etc., from the collected state data of the at least one wearable, with the aid of suitable machine-learning algorithms.

In addition, or alternatively, the sensor unit 112 can comprise at least one ECG seat which is configured to collect physiological data about a vehicle occupant, wherein the state data comprise the data of the ECG seat. In this case, the computing unit 114 can be configured to determine states of the vehicle occupants, for example, a sudden increase or a sudden decrease in the blood pressure, suddenly occurring irregularities in the heartbeat, etc., from the collected state data of the at least one ECG seat, with the aid of suitable machine-learning algorithms.

In addition, or alternatively, the sensor unit 112 can comprise at least one other sensor which is configured to collect data with respect to a current state of the vehicle occupants; wherein the driving behavior data comprise the collected data of the at least one other sensor. In this case, the computing unit 114 can be configured to determine states of the vehicle occupants from the collected state data of the at least one additional sensor, with the aid of suitable machine-learning algorithms.

Particular states and/or any arbitrary combination of particular states of the vehicle occupants may be classified and/or learned as indicating a potential hazard, such that the computing unit 114 can determine the potential hazard with the aid of suitable machine-learning algorithms.

The vehicle 110 comprises an interaction unit which is configured to interact with the vehicle occupants in the case of an identified potential hazard, in order to identify a hazardous location in road traffic by means of the interaction with the vehicle occupants.

For example, the interaction unit can be configured to inquire specifically why a particular state or a particular combination of states of one or several vehicle occupants exists, which was determined by the computing unit 114 to be a potential hazard. This may, for example, comprise a specific inquiry: “I have detected an exclamation of fright/disgust. In addition, I have determined that all vehicle occupants have an elevated pulse rate. Has something happened on the roadway?” Based on the response by the vehicle occupant or occupants, for example, “yes, a car is on fire” or “no, we're just having a silly argument,” the interaction unit can identify a hazardous location in road traffic.

In addition, the vehicle comprises a communication unit 118. This communication unit is configured to transmit the identified hazardous location to the back end 120, along with the associated geographical position at which the vehicle was situated at the time of the identified potential hazard.

In order to obtain the geographical position, the vehicle 110 can comprise a navigation module. For detecting or determining the geographical position, this module can determine or collect current position data with the aid of a navigation satellite system. The navigation satellite system can be any current or future global navigation satellite system (GNSS) for position determination and navigation by means of the reception of the signals from navigation satellites and/or pseudolites. For example, it can be the Global Positioning System (GPS), GLObal NAvigation Satellite System (GLONASS), Galileo positioning system, and/or BeiDou Navigation Satellite System. In the example of GPS, the navigation module can comprise a GPS module which is configured to determine instantaneous GPS position data of the vehicle 110.

Advantageously, by means of targeted interaction with the vehicle occupants, a potential hazard can be identified in near-real time, which is not possible by means of a pure sensor data evaluation.

The back end 120 can be configured to transmit warning data with respect to the identified hazardous location to a plurality of vehicles, and/or to transmit a route detour around the identified hazardous location to a plurality of vehicles, of which the current route comprises the identified hazardous location.

Advantageously, the hazardous situation can thus be transmitted to a plurality of vehicles in near-real time, in particular if their current route comprises the identified hazardous location.

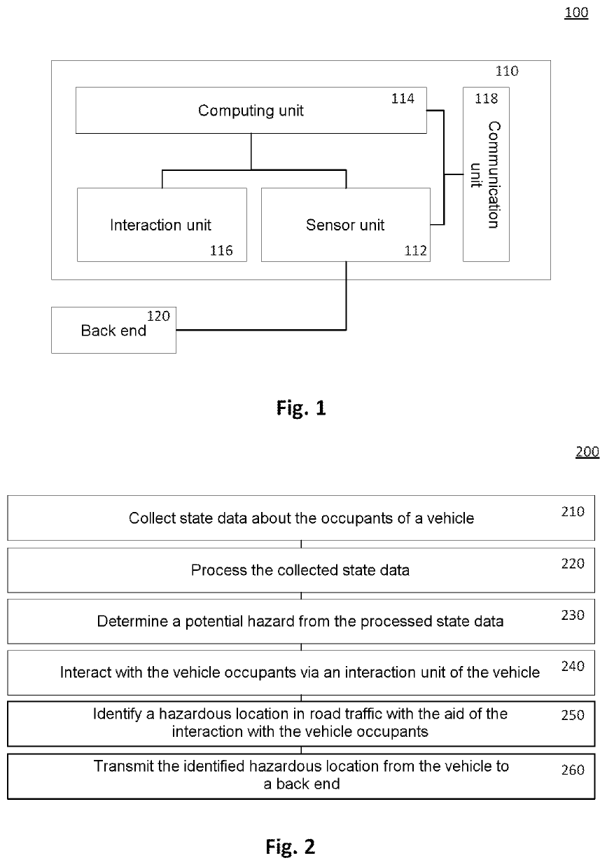

FIG. 2 depicts a method 200 for the real-time identification of hazardous locations in road traffic, which can be carried out by a system 100 as described with respect to FIG. 1.

The method 200 comprises: collecting 210 state data about the occupants of the vehicle 110 by means of a sensor unit 112 of a vehicle 110; processing 220 the collected state data by means of a computing unit 114 of the vehicle; determining 230 a potential hazard by means of the computing unit 114; interacting 240 with the vehicle occupants by means of an interaction unit 116 of the vehicle; identifying 250 a hazardous location in road traffic by means of the interaction unit 116, based on the interaction with the vehicle occupants; and transmitting 260 the identified hazardous location to a back end 120, by means of a communication unit 118 of the vehicle.

The sensor unit 112 can comprise:
at least one interior camera which is configured to collect data with respect to a current state of the vehicle occupants, wherein the state data comprise the data of the interior camera; and/or
at least one microphone which is configured to detect sounds made by the vehicle occupants, wherein the state data comprise the data of the microphone; and/or
at least one wearable which is configured to collect physiological data about the vehicle occupants, wherein the state data comprise the data of the wearables; and/or
at least one ECG seat which is configured to collect physiological data about the vehicle occupants, wherein the state data comprise the data of the ECG seat; and/or
at least one other sensor which is configured to collect data with respect to a current state of the vehicle occupants; wherein the driving behavior data comprise the collected data of the at least one other sensor.

The back end 120 can be configured to transmit warning data with respect to the identified hazardous location to a plurality of vehicles, and/or to transmit a route detour around the identified hazardous location to a plurality of vehicles, of which the current route comprises the identified hazardous location.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A system for the real-time identification of hazardous locations in road traffic, comprising:
a back end;
at least one vehicle, comprising:
a sensor unit configured to collect state data about the occupants of the vehicle;
a computing unit configured to: process the collected state data, and determine a potential hazard from the processed state data; and
an interaction unit configured to: interact with the vehicle occupants in the case of an identified potential hazard, and identify a hazardous location in road traffic by means of the interaction with the vehicle occupants; and
a communication unit configured to transmit the identified hazardous location to the back end.

2. The sensor according to claim 1, wherein the sensor unit comprises:
at least one interior camera which is configured to collect data with respect to a current state of the vehicle occupants, wherein the state data comprise the data of the interior camera; and/or
at least one microphone which is configured to detect sounds made by the vehicle occupants, wherein the state data comprise the data of the microphone; and/or
at least one wearable which is configured to collect physiological data about the vehicle occupants, wherein the state data comprise the data of the wearables; and/or
at least one EKG seat which is configured to collect physiological data about the vehicle occupants, wherein the state data comprise the data of the EKG seat; and/or
at least one other sensor which is configured to collect data with respect to a current state of the vehicle occupants; wherein the driving behavior data comprise the collected data of the at least one other sensor.

3. The system according to claim 2, wherein the back end is configured to transmit warning data with respect to the identified hazardous location to a plurality of vehicles, and/or to transmit a route detour around the identified hazardous location to a plurality of vehicles, of which the current route comprises the identified hazardous location.

4. The system according to claim 1, wherein the back end is configured to transmit warning data with respect to the identified hazardous location to a plurality of vehicles, and/or to transmit a route detour around the identified hazardous location to a plurality of vehicles, of which the current route comprises the identified hazardous location.

5. A method for the real-time identification of hazardous locations in road traffic, comprising:
collecting state data about the occupants of a vehicle by means of a sensor unit of the vehicle;
processing the collected state data by means of a computing unit of the vehicle;
determining a potential hazard from the processed state data, by means of the computing unit;
interacting with the vehicle occupants by means of an interaction unit of the vehicle;
identifying a hazardous location in road traffic by means of the interaction unit, based on the interaction with the vehicle occupants; and
transmitting the identified hazardous location to a back end, by means of a communication unit of the vehicle.

6. The method according to claim 5, wherein the sensor unit comprises:
at least one interior camera which is configured to collect data with respect to a current state of the vehicle occupants, wherein the state data comprise the data of the interior camera; and/or
at least one microphone which is configured to detect sounds made by the vehicle occupants, wherein the state data comprise the data of the microphone; and/or
at least one wearable which is configured to collect physiological data about the vehicle occupants, wherein the state data comprise the data of the wearables; and/or
at least one EKG seat which is configured to collect physiological data about the vehicle occupants, wherein the state data comprise the data of the EKG seat; and/or
at least one other sensor which is configured to collect data with respect to a current state of the vehicle occupants; wherein the driving behavior data comprise the collected data of the at least one other sensor.

7. The method according to claim 6, wherein the back end is configured to transmit warning data with respect to the identified hazardous location to a plurality of vehicles, and/or to transmit a route detour around the identified hazardous location to a plurality of vehicles, of which the current route comprises the identified hazardous location.

8. The method according to claim 5, wherein the back end is configured to transmit warning data with respect to the identified hazardous location to a plurality of vehicles, and/or to transmit a route detour around the identified hazardous location to a plurality of vehicles, of which the current route comprises the identified hazardous location.
